(19) United States
(12) Patent Application Publication
(10) Pub. No.: US 2014/0293786 A1
(43) Pub. Date: Oct. 2, 2014

(54) Path Resolution for Hierarchical Load Distribution

(71) Applicant: Broadcom Corporation, Irvine, CA (US)

(72) Inventors: Meg Pei Lin, Saratoga, CA (US); Puneet Agarwal, Cupertino, CA (US); Liav Leshem, Mountain View, CA (US)

(73) Assignee: Broadcom Corporation, Irvine, CA (US)

(21) Appl. No.: 14/025,114

(22) Filed: Sep. 12, 2013

Related U.S. Application Data
(60) Provisional application No. 61/807,181, filed on Apr. 1, 2013.

(51) Int. Cl. H04L 12/801

(52) U.S. Cl. CPC H04L 47/17
USPC 370/235

(57) ABSTRACT

Network devices perform multiple stage path resolution. The path resolution may be ECMP resolution. Any particular stage of the multiple stage path resolution may be skipped under certain conditions. Further, the network device facilitate redistribution of traffic when a next hop goes down in a fast, efficient manner, and without reassigning traffic that was going to other unaffected next hops, using multiple stage ECMP resolution.

### 1. PRIORITY CLAIM

This application claims priority to, and incorporates by reference, U.S. Provisional Patent Application Ser. No. 61/807,181, filed 1 Apr. 2013.

### 2. TECHNICAL FIELD

This disclosure relates to networking. This disclosure also relates to path resolution in network devices such as switches and routers.

### 3. BACKGROUND

High speed data networks form part of the backbone of what has become indispensable worldwide data connectivity. Within the data networks, network devices such as switching devices direct data packets from source ports to destination ports, helping to eventually guide the data packets from a source to a destination. Improvements in packet handling, including improvements in path resolution, will further enhance performance of data networks.

### BRIEF DESCRIPTION OF THE DRAWINGS

The innovation may be better understood with reference to the following drawings and description.

FIG. 1 shows an example of a switch architecture that may include packet marking functionality.

FIG. 2 is an example switch architecture extended to include packet marking functionality.

FIG. 3 shows an example of Equal Cost Multi-Path (ECMP) resolution.

FIG. 4 shows an example of an overlay network.

FIG. 5 shows an example of path weighting.

FIGS. 6-9 show examples of multiple stage ECMP resolution.

FIGS. 10-11 show example of traffic redistribution.

FIGS. 12-13 shows logic for multiple stage ECMP resolution and traffic redistribution.

### DETAILED DESCRIPTION

Example Architecture

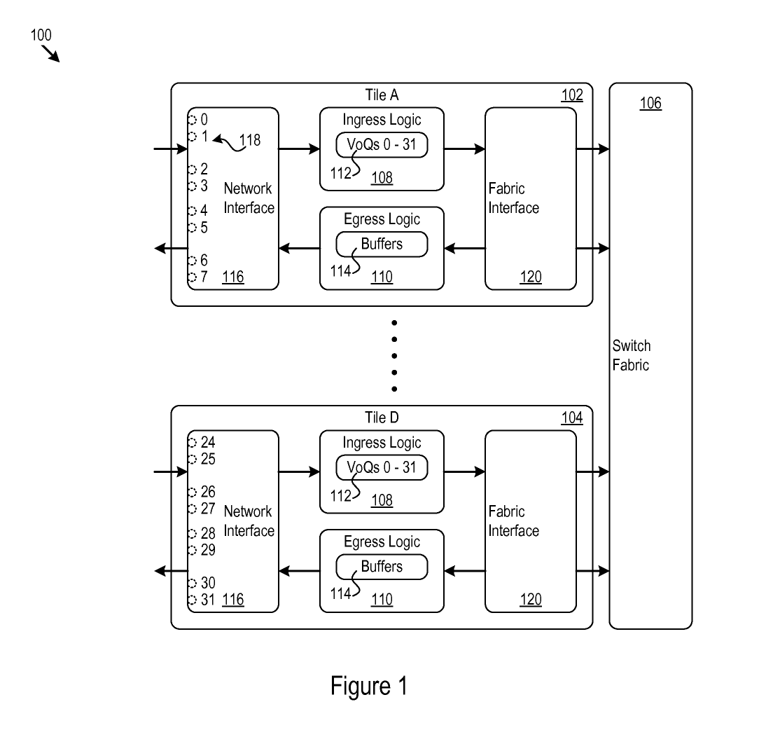

FIG. 1 shows an example of a switch architecture 100 that may include path resolution functionality. The description below provides a backdrop and a context for the explanation of path resolution, which follows this example architecture description. Path resolution may be performed in many different network devices in many different ways. Accordingly, the example switch architecture 100 is presented as just one of many possible network device architectures that may include path resolution functionality, and the example provided in FIG. 1 is one of many different possible alternatives. The techniques described further below are not limited to any specific device architecture.

The switch architecture 100 includes several tiles, such as the tiles specifically labeled as tile A 102 and the tile D 104. In this example, each tile has processing logic for handling packet ingress and processing logic for handling packet egress. A switch fabric 106 connects the tiles. Packets, sent for example by source network devices such as application servers, arrive at the network interfaces 116. The network interfaces 116 may include any number of physical ports 118. The ingress logic 108 buffers the packets in memory buffers. Under control of the switch architecture 100, the packets flow from an ingress tile, through the fabric interface 120 through the switching fabric 106, to an egress tile, and into egress buffers in the receiving tile. The egress logic sends the packets out of specific ports toward their ultimate destination network device, such as a destination application server.

Each ingress tile and egress tile may be implemented as a unit (e.g., on a single die or system on a chip), as opposed to physically separate units. Each tile may handle multiple ports, any of which may be configured to be input only, output only, or bi-directional. Thus, each tile may be locally responsible for the reception, queueing, processing, and transmission of packets received and sent over the ports associated with that tile.

As an example, in FIG. 1 the tile A 102 includes 8 ports labeled 0 through 7, and the tile D 104 includes 8 ports labeled 24 through 31. Each port may provide a physical interface to other networks or network devices, such as through a physical network cable (e.g., an Ethernet cable). Furthermore, each port may have its own line rate (i.e., the rate at which packets are received and/or sent on the physical interface). For example, the line rates may be 10 Mbps, 100 Mbps, 1 Gbps, or any other line rate.

The techniques described below are not limited to any particular configuration of line rate, number of ports, or number of tiles, nor to any particular network device architecture. Instead, the techniques described below are applicable to any network device that incorporates the path resolution analysis logic described below. The network devices may be switches, routers, bridges, blades, hubs, or any other network device that handles routing packets from sources to destinations through a network. The network devices are part of one or more networks that connect, for example, application servers together across the networks. The network devices may be present in one or more data centers that are responsible for routing packets from a source to a destination.

The tiles include packet processing logic, which may include ingress logic 108, egress logic 110, analysis logic, and any other logic in support of the functions of the network device. The ingress logic 108 processes incoming packets, including buffering the incoming packets by storing the packets in memory. The ingress logic 108 may define, for example, virtual output queues 112 (VoQs), by which the ingress logic 108 maintains one or more queues linking packets in memory for the egress ports. The ingress logic 108 maps incoming packets from input ports to output ports, and determines the VoQ to be used for linking the incoming packet in memory. The mapping may include, as examples, analyzing addressee information in the packet headers, and performing a lookup in a mapping table that matches addressee information to output port(s).

The egress logic 110 may maintain one or more output buffers 114 for one or more of the ports in its tile. The egress logic 110 in any tile may monitor the output buffers 114 for congestion. When the egress logic 110 senses congestion (e.g., when any particular output buffer for any particular port is within a threshold of reaching capacity), the egress logic 110 may throttle back its rate of granting bandwidth credit to the ingress logic 108 in any tile for bandwidth of the congested output port. The ingress logic 108 responds by reducing the rate at which packets are sent to the egress logic 110, and therefore to the output ports associated with the congested output buffers.

The ingress logic 108 receives packets arriving at the tiles through the network interface 116. In the ingress logic 108, a packet processor may perform link-layer processing, tunnel termination, forwarding, filtering, and other packet processing functions on the received packets. The packets may then flow to an ingress traffic manager (ITM). The ITM writes the packet data to a buffer, from which the ITM may decide whether to accept or reject the packet. The ITM associates accepted packets to a specific VoQ, e.g., for a particular output port. The ingress logic 108 may manage one or more VoQs that are linked to or associated with any particular output port. Each VoQ may hold packets of any particular characteristic, such as output port, class of service (COS), priority, packet type, or other characteristic.

The ITM, upon linking the packet to a VoQ, generates an enqueue report. The ITM may also send the enqueue report to an ingress packet scheduler. The enqueue report may include the VoQ number, queue size, and other information. The ITM may further determine whether a received packet should be placed on a cut-through path or on a store and forward path. If the receive packet should be on a cut-through path, then the ITM may send the packet directly to an output port with as low latency as possible as unscheduled traffic, and without waiting for or checking for any available bandwidth credit for the output port. The ITM may also perform packet dequeueing functions, such as retrieving packets from memory, forwarding the packets to the destination egress tiles, and issuing dequeue reports. The ITM may also perform buffer management, such as admission control, maintaining queue and device statistics, triggering flow control, and other management functions.

In the egress logic 110, packets arrive via the fabric interface 120. A packet processor may write the received packets into an output buffer 114 (e.g., a queue for an output port through which the packet will exit) in the egress traffic manager (ETM). Packets are scheduled for transmission and pass through an egress transmit packet processor (ETPP) and ultimately out of the output ports.

The ETM may perform, as examples: egress packet reassembly, through which incoming cells that arrive interleaved from multiple source tiles are reassembled according to source tile contexts that are maintained for reassembly purposes; egress multicast replication, through which the egress tile supports packet replication to physical and logical ports at the egress tile; and buffer management, through which, prior to enqueueing the packet, admission control tests are performed based on resource utilization (i.e., buffer and packet descriptors). The ETM may also perform packet enqueue/dequeue, by processing enqueue requests coming from the ERPP to store incoming frames into per egress port class of service (CoS) queues prior to transmission (there may be any number of such CoS queues, such as 2, 4, or 8) per output port.

The ETM may also include an egress packet scheduler to determine packet dequeue events, resulting in packets flowing from the ETM to the ETPP. The ETM may also perform egress packet scheduling by arbitrating across the outgoing ports and COS queues handled by the tile, to select packets for transmission; flow control of egress credit scheduler (ECS), by which, based on total egress tile, per egress port, and per egress port and queue buffer utilization, flow control is sent to the ECS to adjust the rate of transmission of credit grants (e.g., by implementing an ON/OFF type of control over credit grants); flow control of tile fabric data receive, through which, based on total ETM buffer utilization, link level flow control is sent to the fabric interface 120 to cease sending any traffic to the ETM.

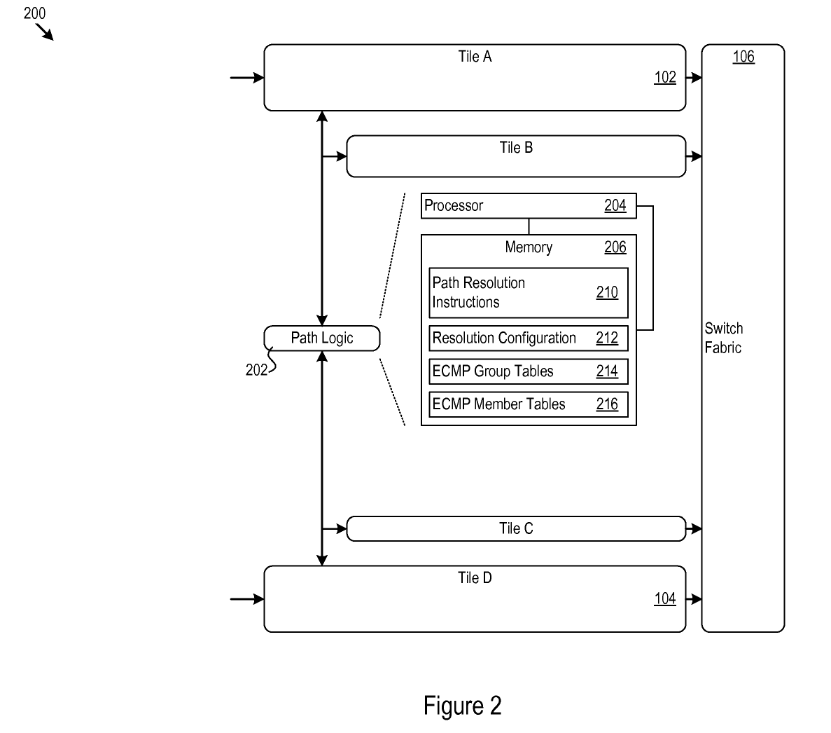

FIG. 2 shows an example architecture 200 which is extended to include the path logic 202. The path logic 202 may be implemented in any combination of hardware, firmware, and software. The path logic 202 may be implemented at any one or more points in the switch architecture 100, or in other architectures in any network device. As examples, the path logic 202 may be a separate controller or processor/memory subsystem. Alternatively, the path logic 202 may be incorporated into, and share the processing resources of the ingress logic 108, egress logic 110, fabric interfaces 120, network interfaces 116, or switch fabric 106.

In the example of FIG. 2, the path logic 202 includes a processor 204 and a memory 206. The memory 206 stores path resolution instructions 210, and resolution configuration information 212. The path resolution instructions 210 may execute multiple stage Equal Cost Multi-Path (ECMP) routing as described below, for example. In that regard, the memory may also store ECMP group tables 214 and ECMP member tables 216, the purpose of which is described in detail below.

The resolution configuration information 212 may guide the operation of the path resolution instructions 210. For example, the resolution configuration information 212 may specify the number of size of ECMP groups, ECMP member tables, may specify hash functions, the number of stages in the path resolution, or other parameters employed by the multiple stage resolution techniques described below.

Path Resolution

In a network of interconnected nodes, there may be multiple paths from a source A to reach a destination B. The nodes may be routers or switches, as examples, or may be other types of network devices. Each node may make an independent decision of which path to take to reach the destination B and each node may determine a next hop node, e.g., the next node along a particular path (the “next hop”) to which to forward the packet. For each packet a node may perform ECMP resolution and may determine the next hop node on one of the equal cost paths to the destination B. One goal of ECMP resolution is to increase bandwidth available between A and B by distributing traffic among the equal cost paths.

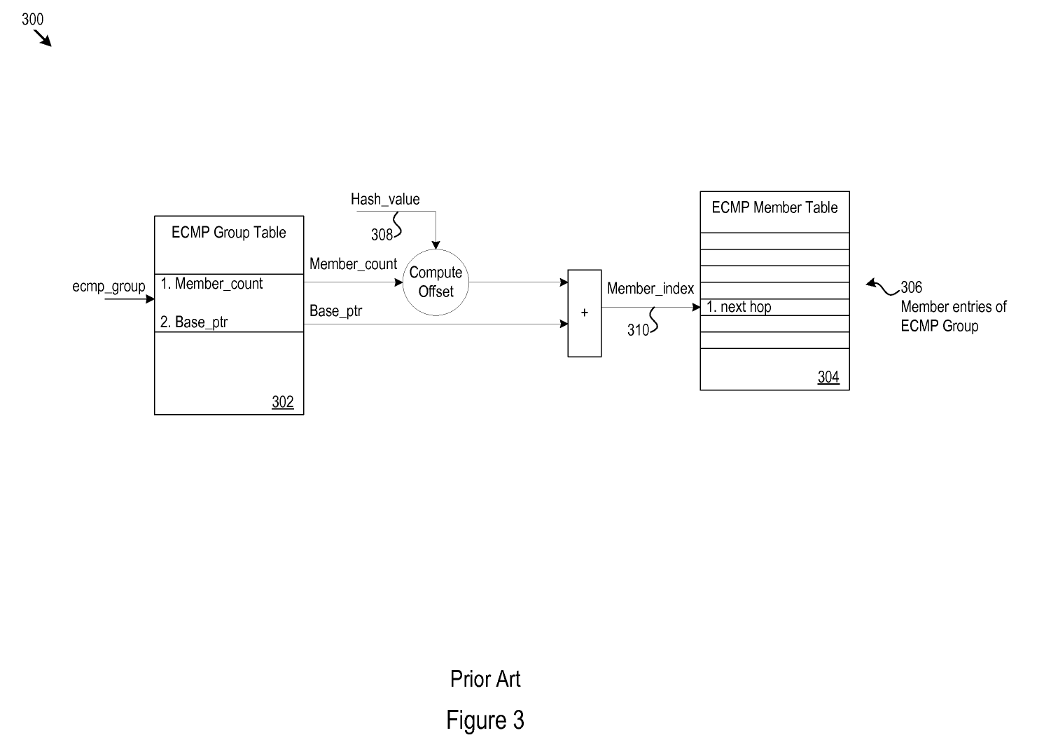

In weighted ECMP, the paths between A and B forming an ECMP group may be weighted differently. The Weighted (W) ECMP (W-ECMP) resolution may then select a path from an ECMP group based on the weights of each path, typically given by the weights on the next hop nodes. FIG. 3 shows an example of W-ECMP resolution 300.

In FIG. 3, the parameter Ecmp_group indexes an ECMP group table 302. The ECMP group table stores ECMP group entries for different ECMP groups. In particular, an entry may include a member count (“member_count”), which indicates the number of entries in the ECMP member table 304 for a particular group, and a base pointer (“base_ptr”), which addresses the first entry in the ECMP member table 304 for the group.

In order to select among potentially multiple next hops 306 in the ECMP member table 304 for the ECMP group, the system may determine a hash value 308. The hash value 308 may be a function of the data in selected packet fields. Given the hash value 308, the next hop may be selected from the ECMP member table 304. In particular, the system may determine the member index 310 into the ECMP member table 304, at which the identifier of the next hop is stored, according to:

member_index=(hash_value %(member_count+1))+base_{—}ptr

Where the ‘%’ operator is the modulo operator: remainder after division.

To accommodate next hops within a group has with different weights, the next hop may appear multiple times in the ECMP member table 304 for the group, in proportion to its weighting. The multiple appearances in the ECMP member table 304 implements the weighting for the next hop by providing additional or fewer entries for the next hop, leading to additional or fewer selections of the next hop.

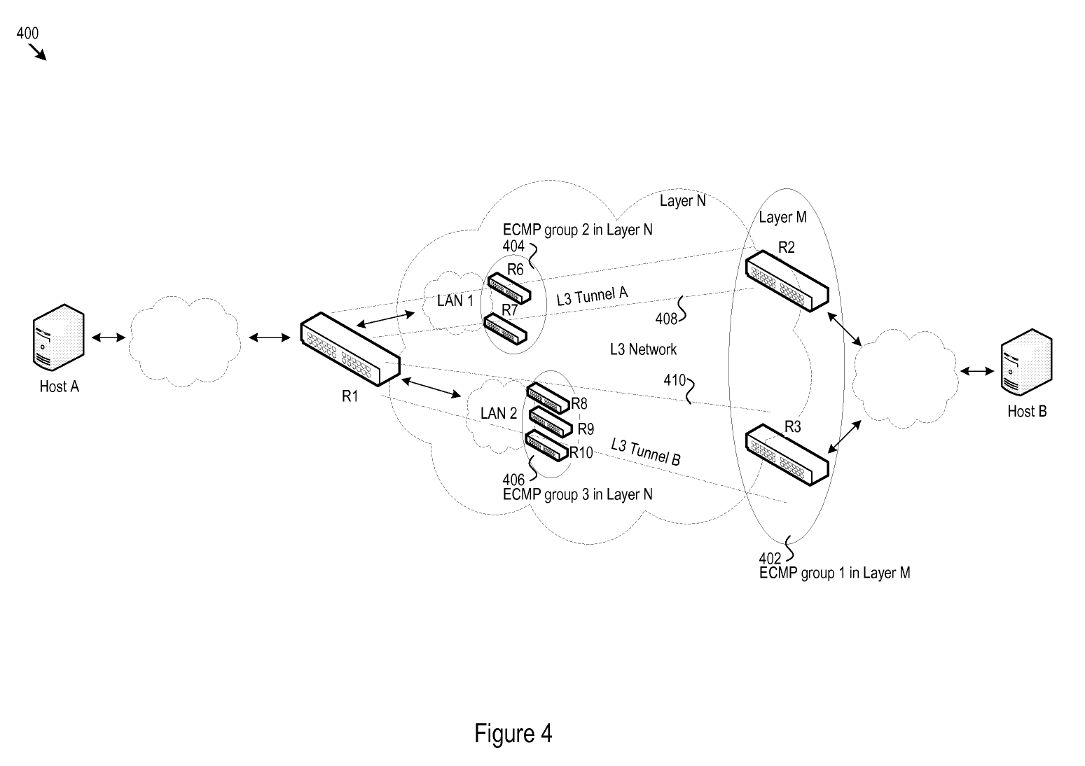

FIG. 4 shows an example of an overlay network 400. An overlay network may include networks running on top of other networks. For example, a datacenter may run an L2 or L3 network over an existing underlying Internet Protocol (IP) network.

In this example, the overlay network 400 includes a layer N and a layer M. Within layer M is a first ECMP group 402. Within layer N is a second ECMP group 404 and a third ECMP group 406. FIG. 4 shows tunnel A 408 between nodes R1 and R2, and tunnel B 410 between nodes R1 and R3. The nodes may be routers, switches, or any other type of network device. In the overlay network 400, assume for example that M is the overlay network running over network N, and that network N is an existing IP network. In FIG. 4, node R1 receives packets originating from Host A and forwards the packets toward Host B, e.g., at layer M and N. In this example, the node R1 may select between the following paths for reaching host B:

{R2, R6}, {R2, R7}, {R3, R8}, {R3, R9}, {R3, R10}

The nodes R6, R7 and R8, R9, R10 are assumed, in this example, to forward only in Layer N. Any node, including the nodes R6-R10, may also perform ECMP resolution to select the next hops in Layer N to reach node R2, or R3 respectively. The example below is given from the perspective of the node R1 making a decision on which node is the next hop for a particular packet it has received.

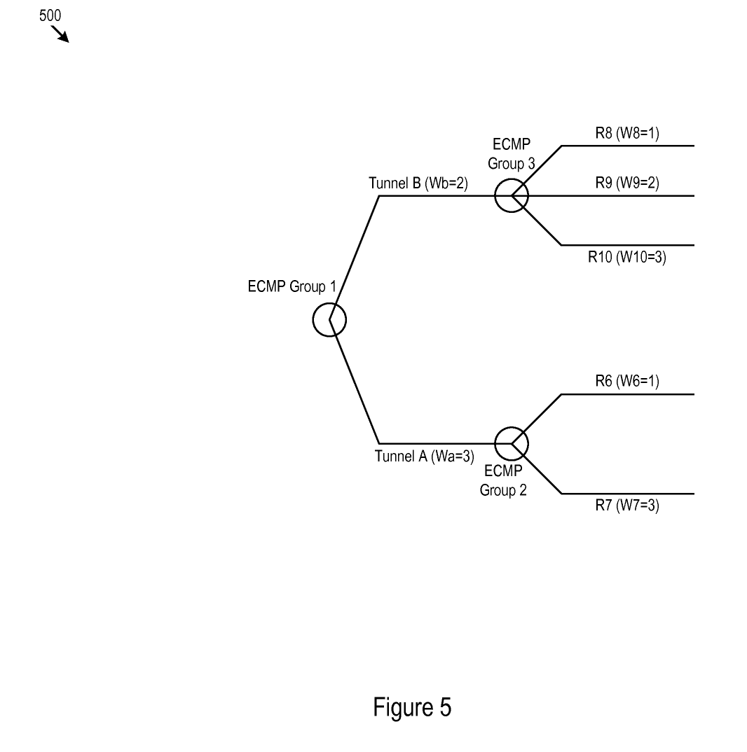

Note that nodes, e.g., R1, in an overlay network may need to resolve ECMP paths in multiple layers. The ECMP paths in one or more layers may be weighted. FIG. 5 shows an example weighting 500 for the paths in FIG. 4 at R1 to reach host B. As shown in FIG. 5, tunnel A 408 has weight 3 and tunnel B 410 has weight 2. Thus, there is a relative weighting for the higher level network, layer M. FIG. 5 shows the weightings for the nodes in the lower level network also, Layer N. Thus, there is also a relative weighting for packet flow within the lower level network.

Table 1, below, summarizes the weights shown in FIG. 5.

TABLE 1

| Entity | Weight | Comment |
|---|---|---|
| Tunnel A | Wa = 3 | The tunnel A will carry 1.5 times the traffic as |
| | | tunnel B (e.g., 3 packets for every 2 packets that |
| | | Tunnel B carries). |
| Tunnel B | Wb = 2 | Two of five packets will travel through Tunnel B. |
| R6 | W6 = 1 | R6 will handle one third as much traffic as R7, |
| | | and ¼ of the traffic for tunnel A |
| R7 | W7 = 3 | R7 will handle 3 times the traffic as R6, and |
| | | ¾th of the traffic for tunnel A |
| R8 | W8 = 1 | R8 handles one sixth of the traffic for tunnel B |
| R9 | W9 = 2 | R9 handles one third of the traffic for tunnel B |
| R10 | W10 = 3 | R10 handles half of the traffic for tunnel B |

To implement the weighting, the number of entries in the ECMP member table may grow as a multiplicative function of the weights. For this example:

[(W8*Wb)+(W9*Wb)+(W10*Wb)]*2+[(W6*Wa)+(W7*Wa)]*3=24+36=60 entries. In other words, there will be 24 entries of next hops from tunnel B and 36 entries of next hops from tunnel A, so that 1.5 times the traffic is routed through tunnel A as is routed through tunnel B. Within the 24 entries for tunnel B, there will be 4 node R8 entries, 8 node R9 entries, and 12 node R10 entries. Within the 36 entries for tunnel A, there will be 9 node R6 entries and 27 node R7 entries.

In other words, the number of entries per node in the ECMP member table reflects the desired percentage of traffic sent through that node. In the example above,

R6 handles (3/5)*(1/4) of all traffic=(3/20)=15% percent of all traffic

R7 handles (3/5)*(3/4)=(9/20)=45%

R8 handles (2/5)*(1/6)=(2/30)=6.66%

R9 handles (2/5)*(2/6)=(4/30)=13.33%

R10 handles (2/5)*(3/6)=(6/30)=20%

Sixty (60) is the least number, n, for which n* percentage of traffic is an integer, for all path probabilities, because 60 includes 20 and 30 as a factor:

60*15%=9 entries for R6

60*45%=27 entries for R7

60*6.66%=4 entries for R8

60*13.33%=8 entries for R9

60*20%=12 entries for R10

When the relative probabilities change, the minimum number of entries will also change, and the minimum number of entries is very often a multiplicative function of the weights. This causes the ECMP member table 304 to grow quickly, consuming valuable resources in the system.

However, with the path resolution techniques described below, the number of ECMP member table entries may be reduced. For the example above, using the techniques described below, the number of ECMP member table entries may be reduced to:

Wa+Wb+W8+W9+W10+W6+W7=15 entries.

In other words, the path resolution techniques described below avoid growth in the number of entries as a function of the multiplication of the weights in the multiple layers. The reduction in the number of entries may translate into, as examples, a lower memory requirement for routing, freeing existing memory for other uses, or permitting less memory to be installed in the node, or other benefits.

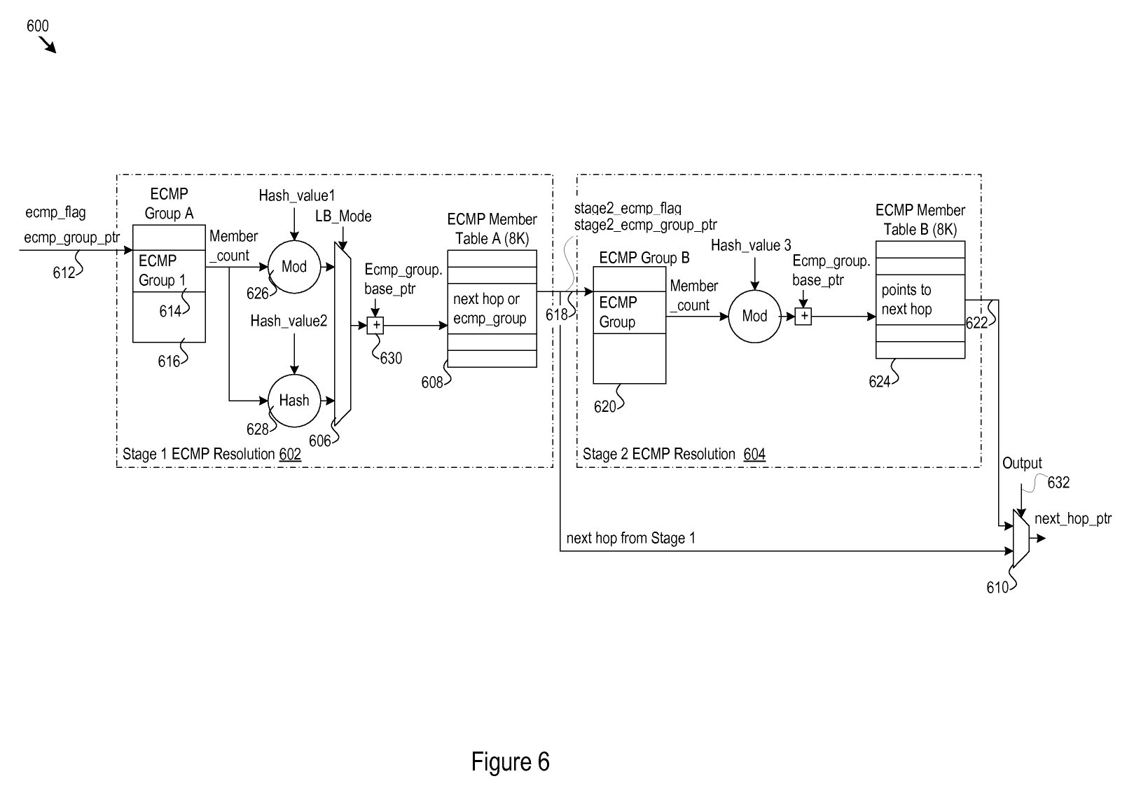

A network device (e.g., as implemented by the architectures 100 and 200, or by other architectures) may perform ECMP resolution in multiple stages. The multiple stage resolution may occur in hardware, or for example by executing the path resolution instructions 210 with the processor 204, or in a combination of hardware and software. Examples of multiple stage ECMP resolution are shown in FIGS. 6-8. In FIG. 6, for example, a system 600 includes a first stage 602 (stage 1) of resolution and a second stage 604 (stage 2) of resolution. As just one example, the stages may resolve in order of higher to lower level layers, with a stage for each layer, and there may be any number of layers.

Continuing the example of FIG. 4, the first stage 602 resolves ECMP in Layer M (e.g., the higher level layer first). For example, an ECMP pointer 612 points to an ECMP group 614 in the ECMP group table 616. The ECMP group 614 specifies the ECMP group 1 412 (e.g., R2 and R3). The stage 1 ECMP member table 608 (e.g., 8K entries in size) implements the relative weighting of R2 and R3 using multiple entries for R2 (e.g., 3 entries as noted in Table 1) and R3 (e.g., 2 entries as noted in Table 1). The output 618 of the first stage 602 may be considered an intermediate path resolution output. In this example, the output 618 of the first stage 602 is an identifier of either ECMP Group 2 (to reach R2) or ECMP Group 3 (to reach R3). Note that both ECMP Group 2 and ECMP Group 3 may point to different places in the ECMP group table 620 where the group 2 and group 3 entries are stored. The second stage 604 performs path resolution for Layer N, in sequence after the first stage 602 has resolved Layer M.

The second stage 604 resolves in Layer N (e.g., proceeding to the next lower network layer). The output 622 of the second stage 604 is next hop R6 or R7 to reach R2 (when stage 1 determined that R2 was the next hop), or next hop R8 or R9 or R10 to reach R3 (when stage 1 determined that R2 was the next hop). The stage 2 ECMP member table 624 (e.g., 8K entries in size) implements the relative weighting of R6, R7, R8, R9, and R10 (e.g., 3 entries for R7 and 1 entry for R6 as noted in Table 1).

FIG. 6 also shows optional mode selection logic 606. The mode selection logic 606 may be responsive to an operational mode, such as load balancing mode (LB_Mode). The load balancing mode selection may select among multiple options for generating an offset into the ECMP member table 608. The LB_Mode may determine whether load balancing between group members (e.g., R2 and R3) occurs based on packet hash values, random values, a counter, or other factors. In the example of FIG. 6, the mode selection logic 606 chooses between a modulo function 626 (e.g., member count modulo a hash value obtained from packet fields) of the member count obtained from the ECMP group table 616 and a hash 628 of the member count. The adder 630 adds the offset output from the mode selection logic 606 to the base address obtained from the ECMP group 614 to obtain an index into the ECMP member table 608 that actually selects the ECMP group for R2 or R3.

Note that the ECMP member table 608 may specify a next hop when, e.g., a single level of resolution is performed, when the current stage resolves down to an actual next hop, or may specify a next ECMP group, e.g., that identifies a group in the next network layer down. A type entry (e.g., a bit field) in the ECMP member table 608 may specify which type of result (e.g., a next hop or a group) is found in any entry in the table. Further, different types of packets may be subject to different numbers of levels of resolution. If in this example, the network device is only forwarding in layer N for a particular packet, then there may be only one ECMP group to check.

Further, the output selection logic 610 may be responsive to the output selection signal 632. The output selection signal 632 may determine whether the path resolution is finished at a particular stage (e.g., finished at stage 1 602). In other words, the output selection signal 632 may force the resolution to end at any given stage, and, as a specific example, to be a single level resolution. The output selection signal 632 may be provided for backwards compatibility and for low latency operation by avoiding multiple sequential table lookups. In that case, the first stage 602 may be configured to operate as previously described, to resolve one or more stages of path selection using many more entries in the ECMP member table 608, for example. In other words, the output selection signal 632 may facilitate operation in a reduced number of levels mode (e.g., a single level mode), in which there may be, in the final stage, a relatively larger ECMP member table as described above that holds a number of entries that may be a multiplicative function of the weights to implementing path weighting.

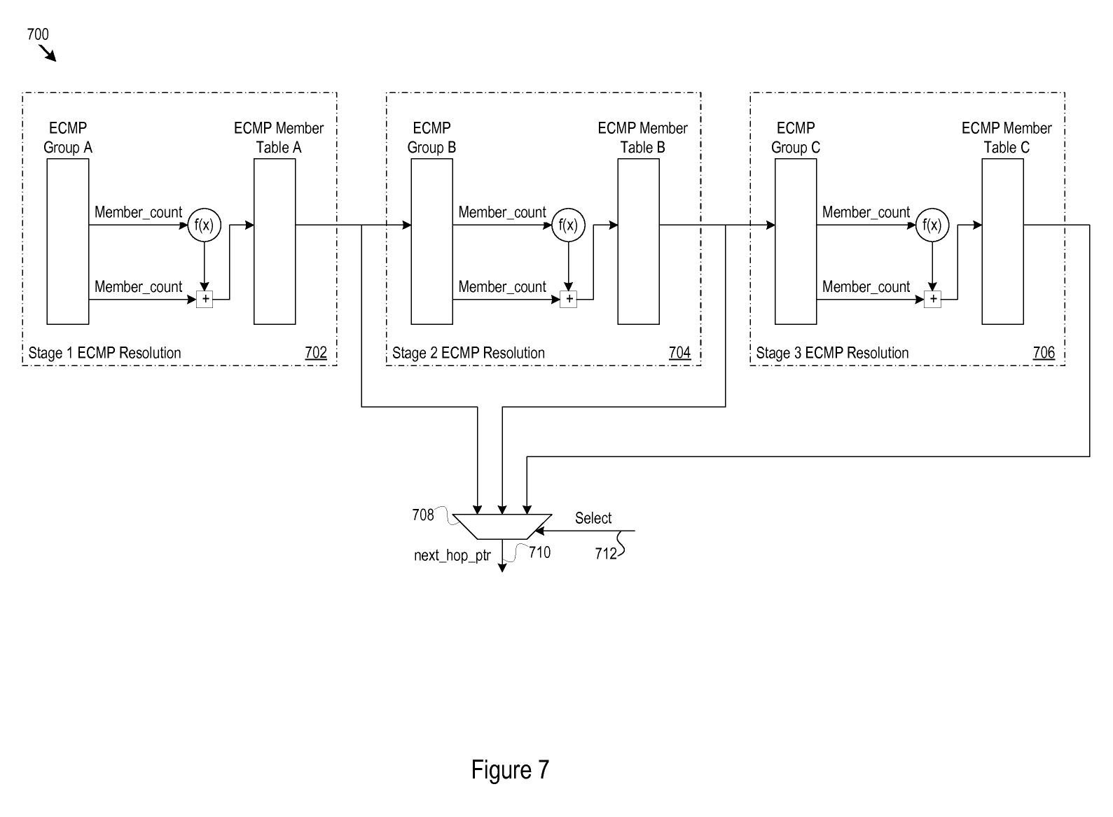

As a specific example, FIG. 7 shows a three stage example 700. The example 700 includes a first stage 702, a second stage 74, and a third stage 706. Output selection logic 708 selects the output of one of the stages as the next hop output 710. An output selection signal 712 provides the control input to the output selection logic 708 to cause the output selection logic 708 to choose the output of one of the three stages for the next hop. With multiple (e.g., 2) stages of resolution, the path resolution may be considered to address multiple (e.g., 2) sequential tables for path resolution, instead of one very large table for path resolution.

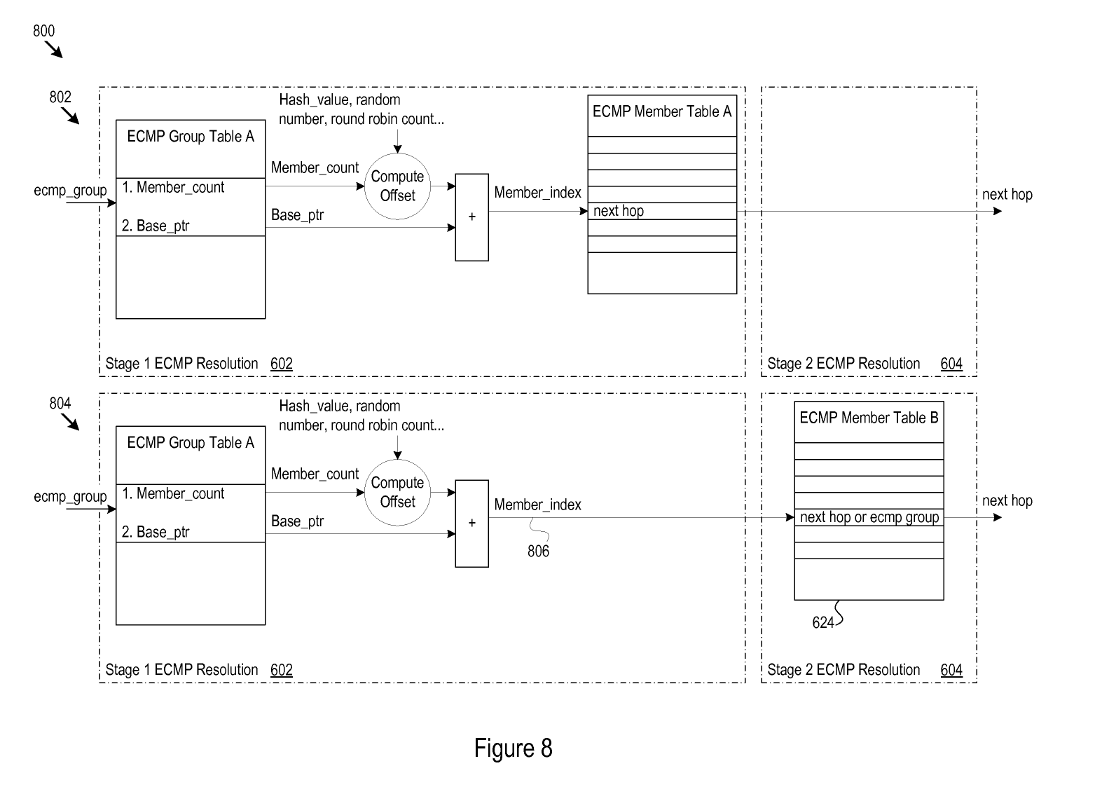

In FIG. 8, the example 802 shows that the output of the first stage 602 can also be a next hop, rather than a pointer into the group table for a subsequent stage. The direct output of a next hop in the first stage 602 may happen, for example, when the network device is forwarding only in a layer that is resolved by the first stage (in this example layer M) for all packets or for selected packets. In other words, the network device may bypass subsequent stages, such as the second stage 604 that ordinarily resolves layer N. In this example, the first stage 602 has resolved the path for layer M, and no further resolution is desired, e.g., because the specific packet does not need further path resolution. In general (and as shown in FIG. 7), when any stage determines an actual next hop, then subsequent stages may be skipped because the actual next hop has been determined. Note also that each output of the multiple stages may be analyzed (e.g., using a multiplexer and the type bits) to select an actual next hop that was found in any stage, as the overall next hop output of the multiple stages.

FIG. 8 also shows an example 804 in which the resolved member index 806 from the first stage 602 points to the ECMP member table 624 in the second stage 604. The member index may be the base pointer for the member table, plus the offset determined, e.g., by the member count. As examples, a modulo function, random number, round robin selection, or other function may determine the offset among the member count number of entries. In other words, the network device may interpret a member index as a pointer to a member table in a different stage. As a result, the ECMP group in any particular stage (e.g., the first stage 602) may have access to entries in an ECMP member table in another stage (e.g., the second stage 604), as well as to entries in the ECMP member table within that particular stage.

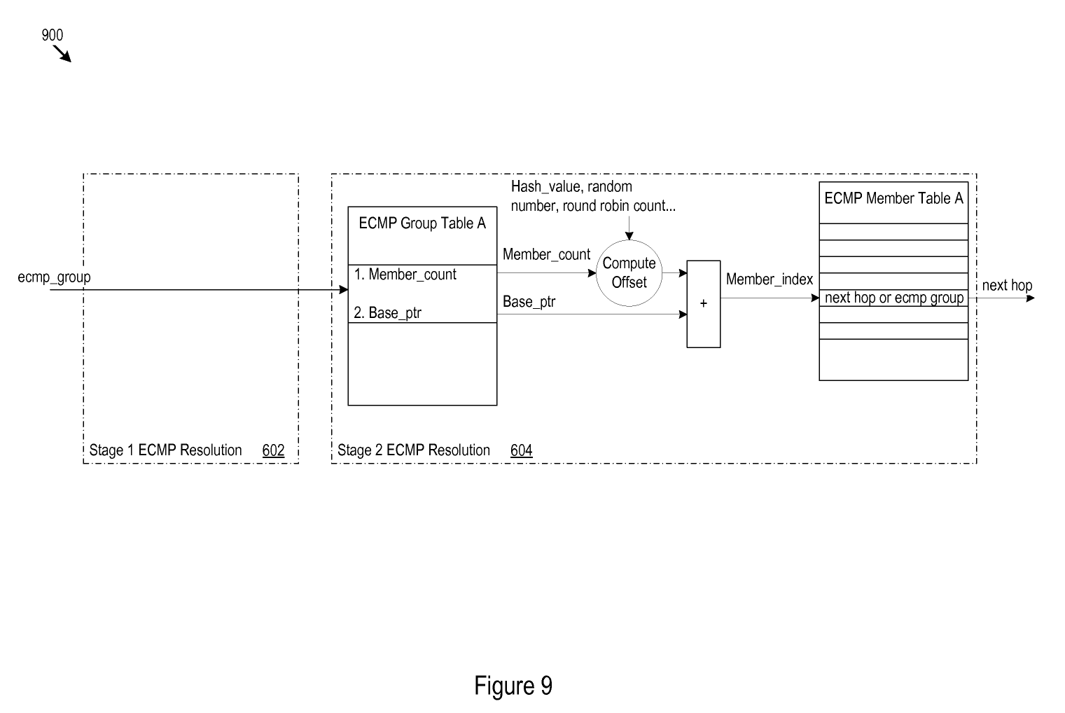

FIG. 9 shows that the first stage 602 may be bypassed if there is no ECMP resolution in Layer M. This may happen, for example, when the network device is forwarding a packet directly to tunnel B in, e.g., an overlay network such as that shown in FIG. 4. In this example, the second stage 604 may resolve ECMP for the layer N tunnel B to select between R6 and R7. Thus, packets may be selectively subject to path resolution in any one or more of the stages in the multiple stage resolution architecture.

Traffic Redistribution

Described below are techniques to redistribute traffic to a downed next hop quickly and without reassigning traffic that was going to other unaffected next hops, using multi-stage ECMP resolution. For the purposes of illustration, assume that node A may forward packets to node B via 3 next hop routers R1, R2, R3, forming an ECMP Group. Assume also that ECMP Group member count is programmed to 3 and ECMP member table has 3 entries, R1, R2, R3. When R3 goes down, the network device updates member count to 2. The update, however, may cause traffic that was not flowing to R3 to be potentially reassigned to a different next hop, and this may result in temporary re-ordering of packets within a flow received at node B.

It may be desirable that only traffic that was previously assigned to R3 should be affected by R3 going down, and that only the R3 traffic should be redirected to either R1 or R2. In other words, traffic previously assigned to R1 should not change assignment to R2 and traffic previously assigned to R2 should not change to R1. It may also take a certain amount of time for the network device to reprogram the ECMP group table and each ECMP member table entry that included an R3 next hop entry (e.g., to remove the entry).

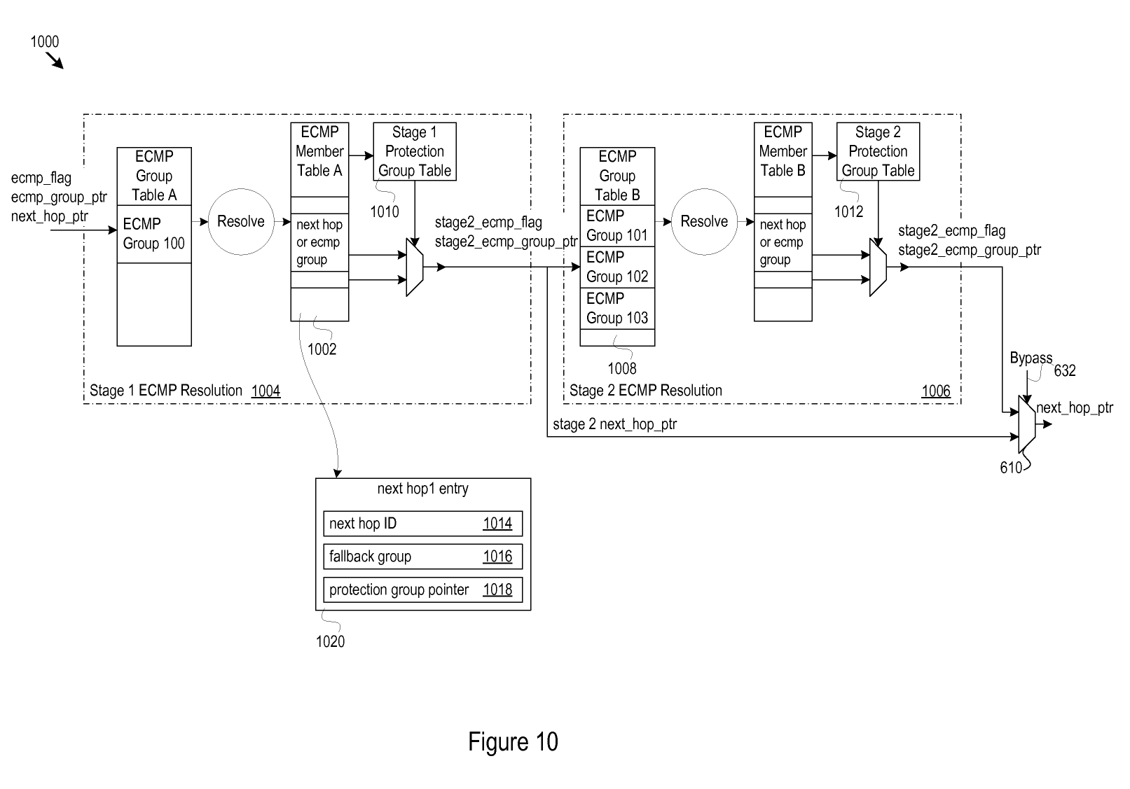

FIG. 10 shows an example traffic redistribution architecture 1000. In the architecture 1000, entries in the ECMP member table A 1002 may include redistribution protection entries. An example member table entry 1020 is shown for next hop 1. The member table entry 1020 includes: next hop ID 1014, which identifies a selected next hop, and the following redistribution protection entries: fallback group 1016, which identifies the ECMP group to use if a protection status is set; and protection group pointer 1018, which points to a protection group table from which to obtain status information. The status information may be, e.g., a bit that indicates whether the next hop is down. FIG. 10 shows examples of protection group tables 1010 and 1012, which are discussed further below.

Continuing the example with respect to FIG. 10, assume that the first stage 1004 ECMP Resolution has ECMP Group 100 containing next hop 1, next hop 2, next hop 3 as members, and that the second stage 1006 ECMP resolution has an ECMP group table 1008 specifying ECMP group 101, 102, and 103. Assume also that ECMP group 101 contains next hop 2 and next hop 3 as members; that ECMP Group 102 contains next hop 1 and next hop 3 as members; and that ECMP Group 103 contains next hop 1 and next hop 2 as members. In this example, the first stage 1004 ECMP member table is configured so that the next hop 1 entry points to protection group 10; the next hop 2 entry points to protection group 20; and the next hop 3 entry points to protection group 30.

Explained more generally, the architecture 1000 may establish fallback ECMP groups that selectively omit specific next hops for which protection is desired. For example, to protect against next hop 1 failure, an ECMP group is defined to include next hop 2 and next hop 3. Similarly, to protect against next hop 2 failure, an ECMP group is defined to include next hop 1 and next hop 3. And, to protect against next hop 3 failure, an ECMP group is defined to include next hop 2 and next hop 1. Accordingly regardless of which next hop fails, there is another ECMP group that omits the failed next hop and that can resolve the next hop in the path by specifying the allowable routing options other than the failed next hop. Note that a processing stage subsequent to the stage that detects the failure may resolve the fallback group.

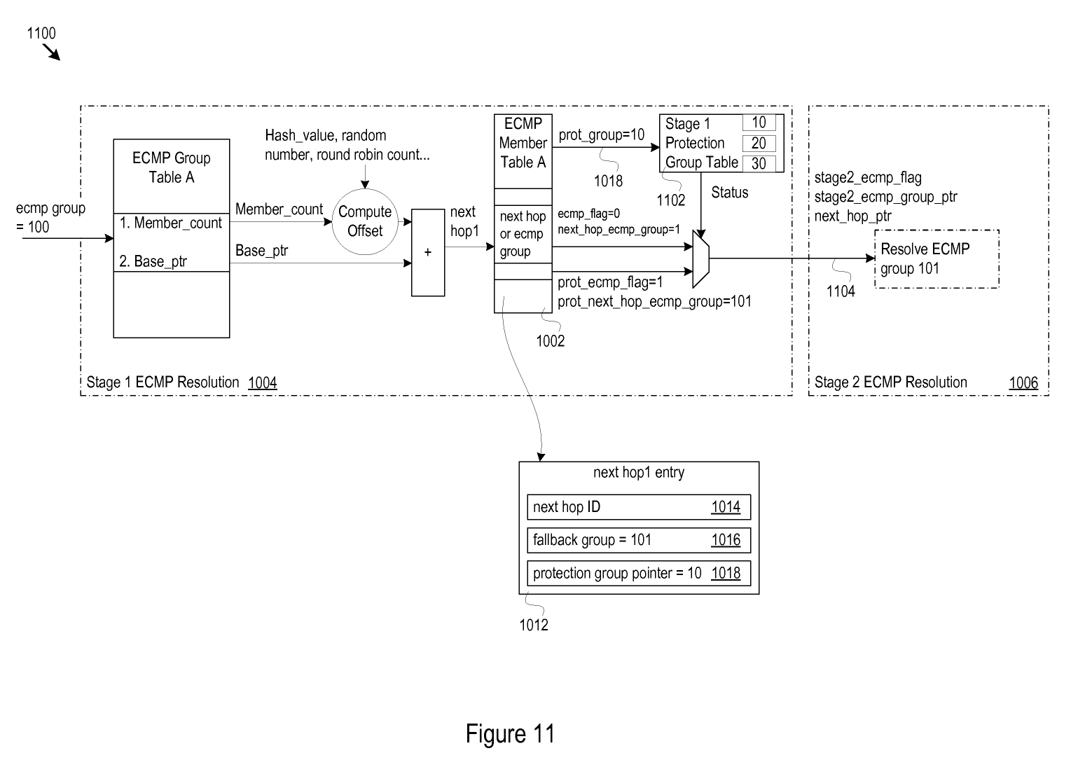

As shown in FIG. 11, the first stage 1004 may resolve ECMP Group 100 to next hop 1, next hop 2 or next hop 3. Since the result of the first stage 1004 is a next hop, the network device need not execute the second stage 1006. When next hop 1 goes down, the network device software may set the status information in the protection group table 1102 accordingly (e.g., by setting a status bit to 1), for protection group 10 defined within the protection group table 1102.

Recall that ECMP member table A 1002 may include member table entries (e.g., the member table entry 1020) that include: next hop ID 1014, which identifies a selected next hop, and the following redistribution protection entries: fallback group 1016 (set to 101 in this example), which identifies the ECMP group to use if a protection status is set; and protection group pointer 1018 (set to 10 in this example), which points to a protection group table from which to obtain status information.

When ECMP Group 100 resolves to next hop 1, the network device retrieves the protection group pointer 1018 from the member table entry 1020, and reads the protection group 10 in the protection group table 1102. The status information for protection group 10 indicates that next hop 1 is down. As a result, the network device selects the fallback ECMP group specified by fallback group 1016: ECMP group 101. Recall that ECMP group 101 includes next hop 2 and next hop 3 as members, and thus will not route any packets through next hop 1.

The network device passes the ECMP group selection (101) to the resolution stage 2 1006. The network device may also set the stage 2 ECMP flag 1104 to indicate that the second stage 1006 should act on the output of the first stage 1004. The second stage 1006 thus resolves ECMP group 101, and obtains either next hop 2 or next hop 3 as a next hop. The second stage 1006 may also check whether the selected next hop is down, using the protection group table, and member table entries described above. Thus, referring back to FIG. 10, the second stage 1006 may also include a protection group table 1012, and provide protection against next hop 2 or next hop 3 going down. Note also that the resolution architecture may provide bypass selection as described with respect to FIG. 6, using the output selection logic 610 and output selection signal 632.

In the approach described in FIGS. 10 and 11, the network device sets, e.g., a bit in the protection group table entry to protect against next hop failures. This may significantly decrease the failover time. In other words, the network device does not need to update all of the entries in the various ECMP member tables that point to next hop 1. Note that the approach described above facilitates fast redirection of traffic to the failed next hop to other members in the ECMP group. Further, the approach does not affect traffic that was not assigned to the failed next hop.

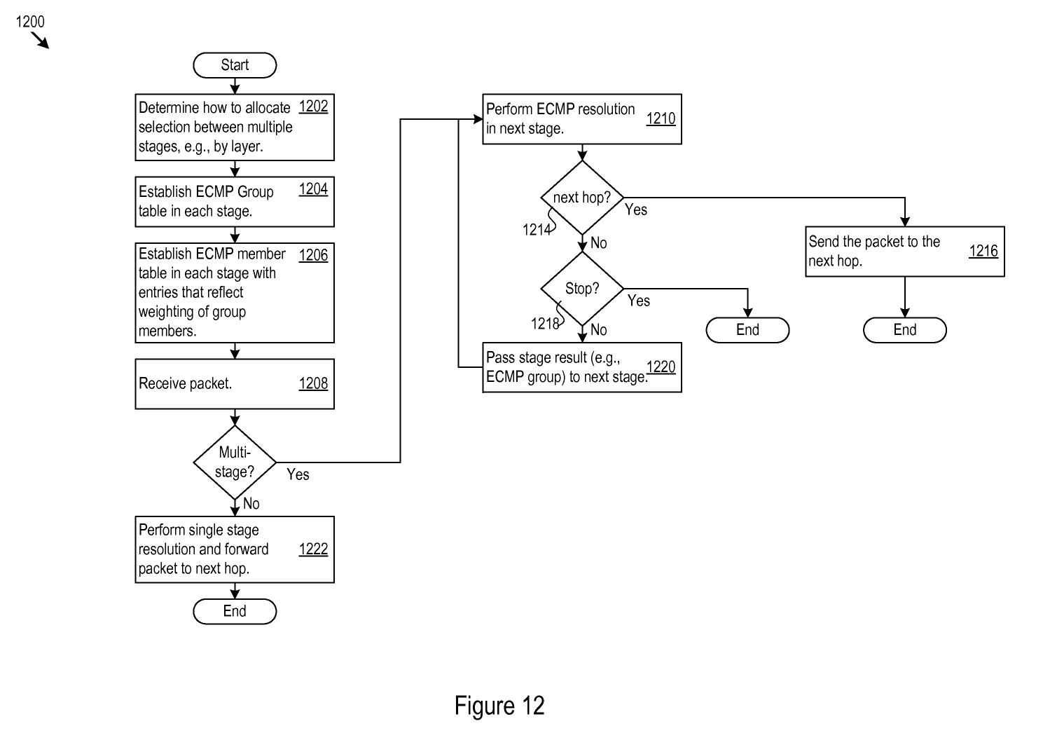

FIG. 12 shows logic 1200 that a network device may implement in hardware, software, or both to perform multiple stage ECMP path resolution. The logic 1200 determines how to allocate selection between multiple stages (1202). The allocation may be by network layer, for example, such that each stage performs ECMP path resolution for a particular network layer (e.g., layer M or N). However, other allocations of path resolution may be made, and some individual stages may be configured to resolve multiple layers, for example.

In each stage, the ECMP group table is established to include a group entry for each group that the stage will handle (1204). In each stage also, an ECMP member table is established to include group member entries for each group that reflect the weighting of the group members in each group (1206).

When the network device receives a packet (1208), the network device may perform multi-stage ECMP resolution. The network device need not use multi-stage ECMP resolution for every packet, however. Instead the network device may decide for which packets to perform ECMP resolution based on packet characteristics and packet criteria that may be present, for example, in the resolution configuration information 212.

When the network device will perform multi-stage ECMP resolution, the network device starts the next stage of resolution (1212). The result of the stage may be a next hop, for example (1214). In that case, the network device may send the packet to the next hop determined by the resolution stage (1216). Note that the network device may stop resolution at any stage (1218). If resolution will continue, then the network device may pass the current resolution stage result on to the next stage (1220). The current resolution stage result may be an identifier of a next group (e.g., for routing in the next network layer), for example. Resolution may continue through as many stages as desired, until a next hop is identified, or until the network device decides to stop the resolution. When multi-stage resolution is not performed, then the logic 1200 may perform single stage resolution and forward the packet to the next hop (1222).

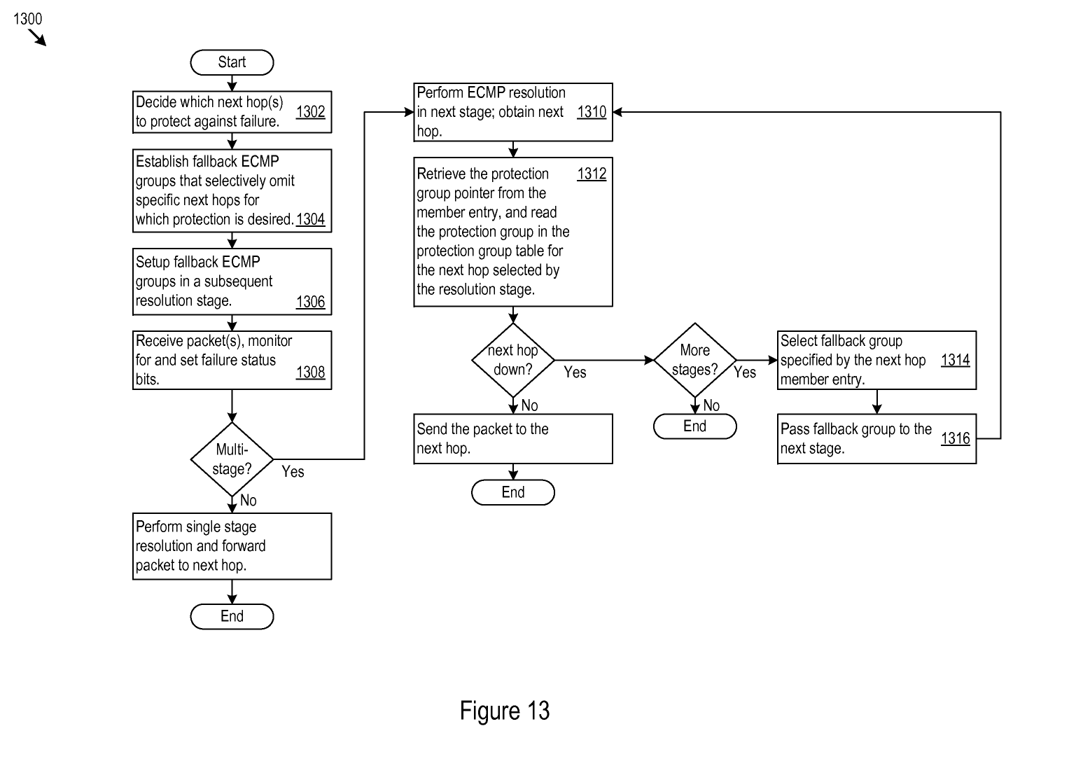

FIG. 13 shows logic 1300 that a network device may implement in hardware, software, or both to perform controlled traffic redistribution, e.g., in a multiple stage ECMP path resolution architecture. The logic 1300 determines how many and which next hop(s) to protect against failure (1302). For example, in an ECMP group of next hop 1, next hop 2, and next hop 3, the logic 1300 may decide to protect against a failure by any of the three next hops. Accordingly, the logic 1300 may establish fallback ECMP groups that selectively omit specific next hops for which protection is desired (1304). For example, to protect against next hop 1 failure, the logic 1300 defines an ECMP group that includes: {next hop 2, next hop 3}. Similarly, to protect against next hop 2 failure, the logic 1300 defines an ECMP group that includes {next hop 1, nop3}, and to protect against next hop 3 failure, the logic 1300 defines an ECMP group that includes: {next hop 2, next hop 1}. Accordingly regardless of which next hops fails, there is another ECMP group that omits the failed next hop and that can resolve the next hop in the path by specifying the allowable routing options that remain. The logic 1300 sets up the fallback ECMP groups in a processing stage subsequent to the stage that is able to detect a failure of an next hop (1306).

During operation, the network device, receives a packet (1308), and also monitors for next hop failure, and sets status bits accordingly, e.g., in the appropriate protection group tables. When the packet is subject to multi-stage path resolution, the logic 1300 submits the packet to the next stage of path resolution (1310). In that respect, the logic 1300 may, for example, retrieve the protection group pointer from the member entry, and read the protection group in the protection group table for the next hop selected by the resolution stage (1312). The protection group table, as noted above, includes status information that indicates whether the next hop is down, and the member group entry for a next hop includes identifies a fallback group to use in the next stage when the next hop is down.

When the next hop determined by the current stage is down, then the logic 1300 may select the fallback ECMP group specified by fallback group identifier in the next hop member entry (1314). The logic 1300 provides the fallback group identifier to the next resolution stage (1316). For example, the logic 1300 may provide a pointer into the ECMP group table in the next stage that points to the fallback group. ECMP resolution may then continue in the subsequent stage, e.g., to select from among the next hops in the fallback group as the next hop for the packet.

The methods, devices, techniques, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability described above may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
in a network device:
providing a first stage of path resolution for forwarding a packet toward a destination; and
providing a second stage of path resolution following the first stage; and
receiving in the second stage an intermediate path resolution output from the first stage, the first stage and second stage configured to sequentially determine a next hop for the packet.

2. The method of claim 1, where:
providing a first stage comprises providing a first stage of equal cost multi-path resolution.

3. The method of claim 2, where:
providing a second stage comprises providing a second stage of equal cost multi-path resolution.

4. The method of claim 1, where the first stage executes path resolution for a first layer of an overlay network.

5. The method of claim 4, where the second stage executes path resolution for a second layer of the overlay network.

6. The method of claim 1, where providing a first stage comprises:
providing an equal cost multi-path (ECMP) group table and an ECMP member table configured to generate the output.

7. The method of claim 6, where receiving comprises:
receiving an ECMP group pointer in the output.

8. The method of claim 7, further comprising:
executing path resolution in the second stage by choosing among members of an ECMP group referenced by the ECMP group pointer.

9. The method of claim 6, further comprising:
providing a load balancing mode selection signal operable to select among multiple options for generating an offset into the ECMP member table.

10. A network device comprising:
a processor; and
a memory in communication with the processor, the memory comprising path resolution instructions configured to:
determine to execute a multiple stage next hop resolution for a received packet;
initiate the multiple stage next hop resolution by determining, in a first stage, a first group of members;
output a selected member from among the first group of members to a second stage, where the selected member comprises a reference to a second group of members in the second stage; and
determine a routing output from among the second group of members.

11. The network device of claim 10, where:
the routing output comprises an identifier of a next hop.

12. The network device of claim 10, where:
the routing output comprises a reference to a third group of members in a third stage subsequent to second stage.

13. The network device of claim 10, where:
the first group of members corresponds to a first network layer.

14. The network device of claim 13, where:
the second group of members corresponds to a second network layer running underneath the first network layer.

15. The network device of claim 10, where the instructions are configure to:
determine the selected member from a member table entry in a member table.

16. The network device of claim 15, where the member table entry comprises:
a protection group pointer to information that specifies whether the selected member is down.

17. The network device of claim 15, where the member table entry comprises:
a fallback group identifier of a fallback group from which to continue next hop resolution in the second stage.

18. The network device of claim 15, where the second group of members comprises multiple entries for a specific next hop according to a relative weighting of the specific next hop.

19. A network device comprising:
a first path resolution stage comprising:
a first stage equal cost multiple path (ECMP) group table identifying a first ECMP group; and
a first stage ECMP member table comprising:
a first member entry comprising a pointer to a different ECMP group table other than the first ECMP group table;
a second path resolution stage configured to receive a path resolution output from the first path resolution stage, the second path resolution stage comprising:
a second stage equal cost multiple path (ECMP) group table identifying a second ECMP group; and
a second stage ECMP member table comprising:
multiple entries for a first next hop in the second ECMP group that implement a first weighting for the first next hop; and
multiple entries for a second next hop in the second ECMP group that implement a second weighting for the second next hop.

20. The network device of claim 19, further comprising:
a load balancing input configured to determine how an offset into the second member table is determined from among multiple options; and
an output selection signal input configured to determine whether path resolution ends at the first stage or at the second stage.
